(19) United States
(12) Patent Application Publication
(10) Pub. No.: US 2008/0120655 A1
(43) Pub. Date: May 22, 2008

(54) Integrated satellite master antenna television unit

(75) Inventors: Jorge H. Guzman, Gaithersburg, MD (US); Linh H. Nguyen, Germantown, MD (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: THE DIRECTV GROUP, INC.

(21) Appl. No.: 11/603,637

(22) Filed: Nov. 22, 2006

(51) Int. Cl. H04N 7/20

(52) U.S. Cl. 725/70

(57) ABSTRACT

A receiving unit 28 includes a plurality of tuner and processor circuit boards 104 that receives a plurality of satellite signals. The tuner and processor circuit boards 104 demodulate and decode the satellite signal to form a plurality of audio and video signals. The plurality of audio and video signals are provided to a modulator and combiner circuit board 110 that is separated from the plurality of tuner circuit boards 104. The modulator and combiner circuit board 104 receives the plurality of audio and video signals and modulates and combines the plurality of audio and video signals to form a modulated and combined output signal. The receiving unit 28 has an integrated bus 100 coupling the plurality of tuner and processor circuit boards with the modulator and combiner circuit board.

### TECHNICAL FIELD

The present disclosure relates generally to receiving units and, more particularly, to receiving units for satellite television and distributing the signals to multiple television in manner such as a head end.

### BACKGROUND

Satellite television has become increasingly popular due to its wide variety of programming. Typical satellite receivers are designed as one integrated unit. That is, the various tuning functions, conditional access functions and processing are all performed on the same circuit board.

For certain types of applications, a satellite master antenna television (SMATV) unit is desirable. The SMATV unit acts as a head end to distribute the downconverted satellite signals to various monitors or televisions for playback. SMATV units are typically targeted at large installations to support multiple users including up to hundreds of simultaneous users. Such systems are typically not economical for low-end installation requiring only a modest number of users. Such applications include low-end commercial applications such as bars, waiting rooms and single-family homes.

Therefore, it would be desirable to provide a system that provides a multiple user system at a lower cost than previously known distribution systems.

### SUMMARY OF THE DISCLOSURE

In one aspect of the disclosure, a receiving unit includes a plurality of tuner and processor circuit boards that receives a first signal that may include a satellite signal. The tuner and processor circuit boards demodulate and decode the satellite signal to form a plurality of audio and video signals. The plurality of audio and video signals is provided to a modulator and combiner circuit board that is separated from the plurality of tuner circuit boards. The modulator and combiner circuit board receives the plurality of audio and video signals and modulates and combines the plurality of audio and video signals to form a modulated and combiner output signal. The receiving unit has an integrated bus coupling the plurality of tuner and processor circuit boards with the modulator and combiner circuit board.

In a further aspect of the disclosure, a method of distributing satellite signals comprises receiving satellite signals from an antenna at the tuner and processor circuit board, demodulating and decoding the satellite signals to form a plurality of first signals at a plurality of tuner and processor circuit boards, communicating the plurality of first signals to a modulator and combiner circuit board, combining the plurality of first signals to form a combined signal, modulating the combined signal to form an output signal and communicating the output signal to a device.

One advantage of the design is that various circuit boards within the design may be upgraded without having to upgrade other circuit boards. Various applications may also use a common tuning and processor circuit board. The higher volume application allows the circuit boards to be manufactured at a reduced cost. This also helps reduce the overall cost of maintenance of the system. That is only a single circuit board of the many circuit boards that may require replacement when upgrading or in the case of a failure. Also, by using the modular design, the device may be easily used or configured for residential as well as commercial applications.

Other advantages and features of the present disclosure will become apparent when viewed in light of the detailed description of the preferred embodiment when taken in conjunction with the attached drawings and appended claims.

### BRIEF DESCRIPTION OF THE DRAWINGS

FIG. 1 is a system level view of a satellite broadcasting system according to the present disclosure.

FIG. 2 is a detailed block diagrammatic view of a receiving unit.

FIG. 3 is a block diagrammatic view of a tuner and processor circuit board.

FIG. 4 is a block diagrammatic view of a modulator and combiner circuit board.

FIG. 5 is a schematic view of one embodiment of the receiving system.

FIG. 6 is a perspective view of one embodiment of the receiving system.

FIG. 7 is a flow chart of a method of receiving a satellite signal according to one aspect of the disclosure.

### DETAILED DESCRIPTION

In the following figures the same reference numerals will be used for the same views. The following figures are described with respect to a satellite television system. However, those skilled in the art will recognize the teachings of the present disclosure may be applied to various types of systems including a cable system.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

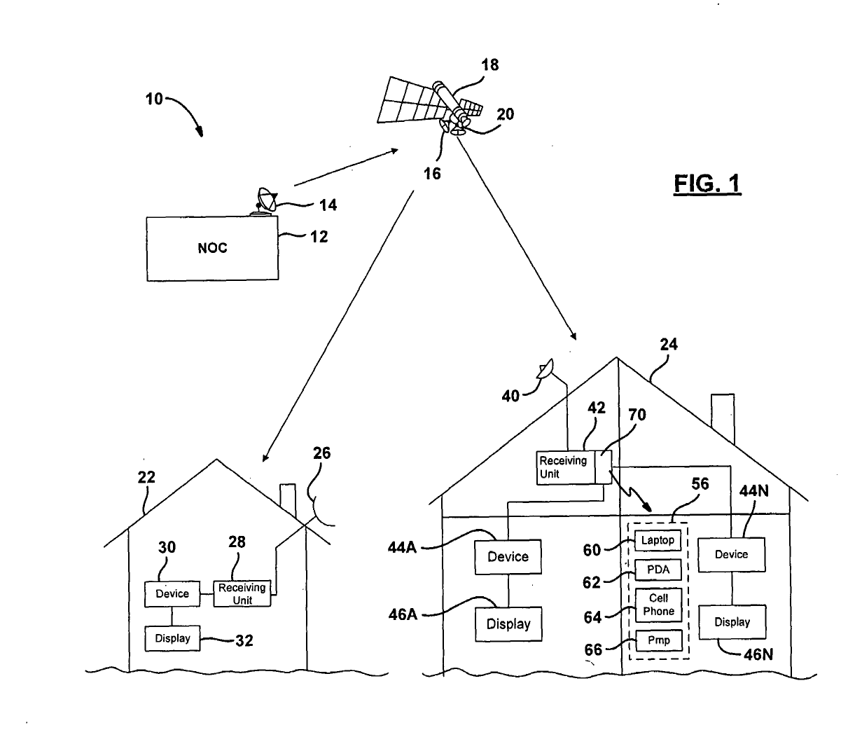

Referring now to FIG. 1, a satellite television broadcasting system 10 is illustrated. The satellite television broadcasting system 10 includes a network operations center 12 that generates wireless uplink signals through a transmitting antenna 14 which are received by a receiving antenna 16 of a satellite 18. The wireless signals, for example, may be digital. A transmitting antenna 20 generates wireless downlink signals directed to various receiving systems including stationary systems such as those in a home 22 as well as multiple dwelling units and commercial buildings 24. The wireless signals may have various types of information associated with them including various channel information such as a channel guide, metadata, location information and the like. The wireless signals may also have various video and audio signal information associated therewith.

The home 22 includes a receiving antenna 26 that receives the wireless signals from the satellite 18 and processes the signals in an integrated satellite master antenna television (SMATV) receiving unit 28. A modulated and combined output signal is generated at the receiving unit 28. A device 30 receives the signal and controls a display 32 in response to the output signal. The display 32 may include both an audio and a video display. The device 30 and display 32 may be a television with a tuner. The receiving unit 28 will be described in further detail below. Multiple devices 30 and multiple displays 32 may be coupled to the receiving device. They may be distributed throughout a household in various rooms. Multiple antennas 26 may also be used.

Building 24 includes a receiving antenna 40 that receives the wireless signals from the satellite 18 and processes the signals in a receiving unit 42. A combined modulated output signal is generated at the receiving unit 42. A plurality of devices 44A-44N in communication with the receiving unit 42 receives the output signal and controls a display 46A-46N in response to the output signal. The displays 46A-46N may include either an audio or a video display, or both.

The present disclosure may also be used for displaying various wireless information on a personal mobile device 36, such as a laptop computer 60, a personal digital assistant 62, a cellular telephone 64 or a portable media device 66. It should be noted that the personal mobile devices 36 may receive wireless signals having various types of information from a video sender 70 that is in communication with the receiving device 42. The video sender 70 may be wireless.

The video sender 70 may also be a wired router for distributing signals to the plurality of devices 44A-44N. The video sender 70 may be an independent unit or incorporated into the receiving unit 42. A video sender 70 may also be an optional feature depending on the system.

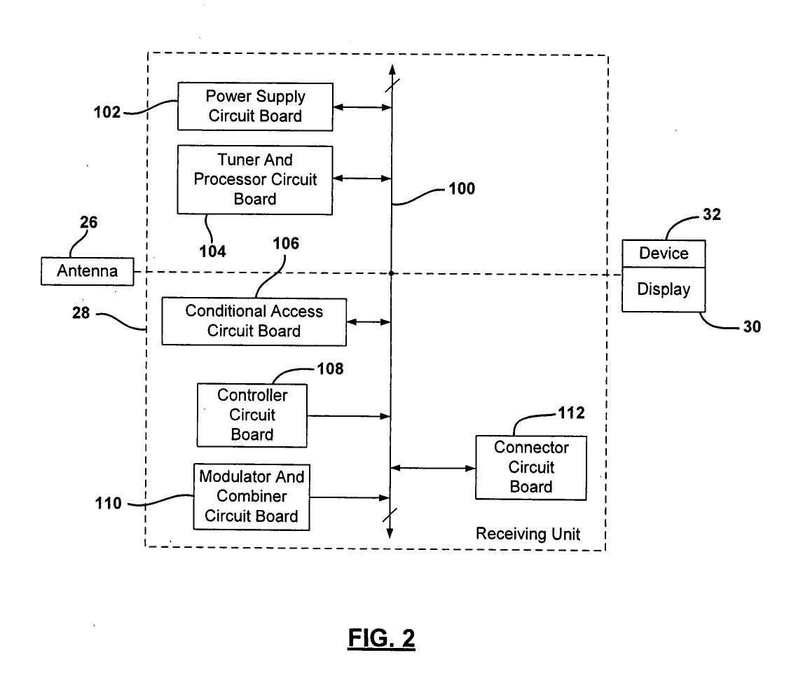

Referring now to FIG. 2, a receiving unit 28 is illustrated in further detail. Antenna 26 may be various types of antennas. The antenna 26 may be a single antenna used for satellite television reception, or a number of antennas. The antenna 26 may also be an electronic antenna.

The receiving unit 28 having an integrated bus 100 may be provided with various circuit boards coupled thereto. The integrated bus 100 preferable includes a common pinout or bus line configuration for each of the circuit boards. The circuit boards may include power supply circuit board 102, a tuner and processor circuit board 104, a conditional access circuit board 106, a controller circuit board 108, a modulator and combiner circuit board 110 and a connector circuit board 112. Each of the circuit boards may communicate with the integrated bus 100. Although only one tuner and processor circuit board 104 is illustrated, multiple tuner and processor circuit boards may be provided. Likewise, multiple modulator and combiner circuit boards 110 may be implemented. The conditional access circuit board 106 may be integrated in the tuner and processor circuit board 104.

It should be also noted that the antenna 26 may also be coupled directly to the integrated bus 100 or to a switch in communication with the tuner and processor circuit board 104 as will be described later. The power supply circuit board 102 may be incorporated on one of the other boards. Likewise, the connector circuit board 112 may be coupled to any one of the circuit boards. It should also be noted that various combinations of more than one of the circuit boards illustrated may be combined together. The combination of the various circuit boards depends upon the desired functions of the system.

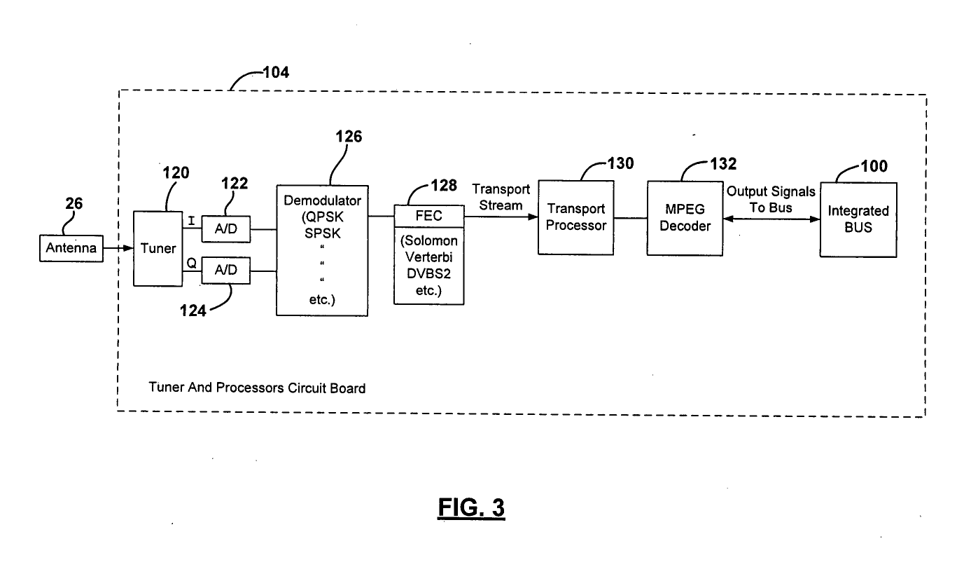

Referring now to FIG. 3, a tuner and processor circuit board 104 is illustrated in further detail. The tuner and processor circuit board 104 is in communication with the antenna 26. The antenna 26 receives the satellite signals. The tuner and processor circuit board 104 may include a tuner 120, which separates the satellite signal into an I signal and a Q signal. A to D converters 122, 124 may also be provided which converts the respective analog I and Q signals to digital signals. A demodulator 126 may also be included on the tuner and processor circuit board 104 as well a forward error correction module 128. The demodulator 126 may be QPSK or an 8PSK or other type of demodulator. The forward error correction module 128 may use Solomon, Verterbi or DVBS2 or the like. The output of the error correction module 128 is connected to the integrated bus 100. Thus, the forward error correction module 128 provides the demodulated and decoded signal which may be referred to as the transport stream. Conditional access circuitry, including a smart card, may be integrated in the tuner and processor circuit board 104.

The transport stream is provided to a transport processor 130 which then provides it to a decoder 132, which decodes the signal for the specific format. As illustrated, the decoder 132 is an MPEG decoder, which generates video and audio signals to the bus 100. The video and audio signals may be provided to a connector on the processor circuit board or a connector on one of the other circuit boards. As will be illustrated below various RCA type jacks, S-video jacks or other types of jacks may be provided. The signal from the tuner and processor circuit board 104 is provide to the modulator and combiner circuit board for distribution to the various devices 30.

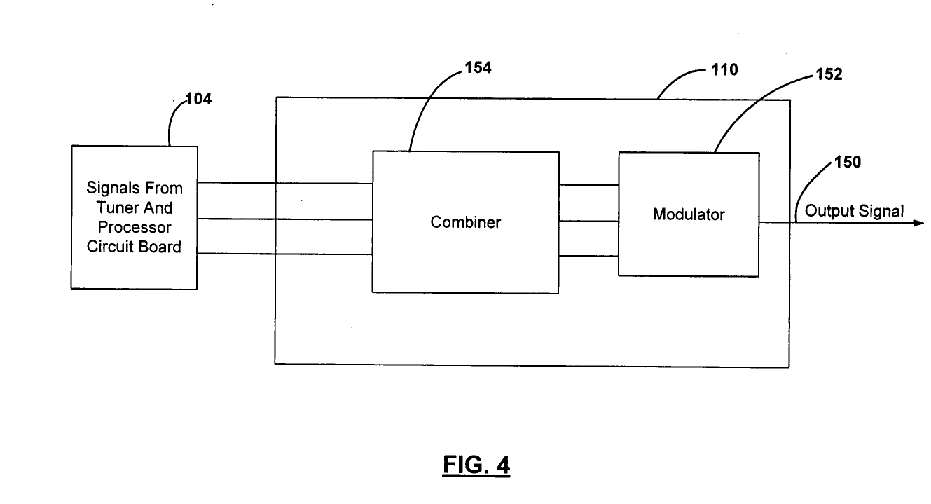

Referring now to FIG. 4, a block diagrammatic view of a modulator and combiner circuit board 110 is illustrated. The modular and combiner circuit board 110 receives signals from multiple tuner and processor circuit boards 104 illustrated in FIG. 3. Each modulator and combiner circuit board 110 may generate an output signal 150. The modulator and combiner circuit board 110 may include one or more modulators 152 that are used to modulate the individual signals from the tuner and processor circuit board. The combiner 154 combines the output signals of multiple tuner and processor circuit boards 104 and the modulator 152 modulates the signals at various frequencies so that they may create the output signal 150. The modulator and combiner circuit board 110 may be a single board or may be a plurality of boards. The output signal 150 may be communicated using a wired connection. As mentioned above, the output signal may be wirelessly communicated using a video sender. The output signal 150 is a modulated and combined signal that combines the outputs of the various tuner and processor circuit boards.

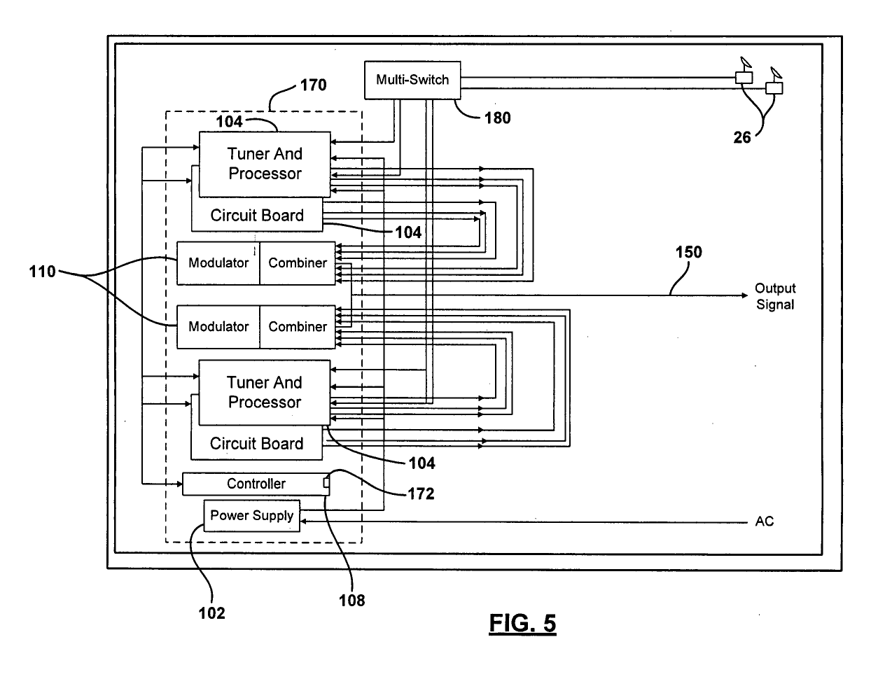

Referring now to FIG. 5, a plurality of tuner and processor circuit boards 104 are shown together with a plurality of modulator and combiner circuit boards 110 in a housing 170. The controller circuit board 108 and power supply 102 is also illustrated. The controller 108 may include a communications port 172 such as an Ethernet, wireless, USB, serial port connection that is used for controlling the tuner and processor circuit boards 104 and the modulator and combiner circuit boards 110. Each of the tuners and processor circuit boards 104 may be coupled to a multi-switch 180. The multi-switch is used to control the antenna 26 to which a tuner and processor circuit board 104 is connected. The antennas 26 may be pointed at various satellites. The antennas 26 may also include various low noise blocks for coupling to various antennas. The multi-switch 180 may be used to couple the particular low noise block of the particular antenna to the desired tuner and processor circuit board. The tuner and processor circuit board 104 controls the multi-switch so that the proper channel may be received by the system. The communications port 172 may be used for channel selection and changing parameters of the various circuit boards.

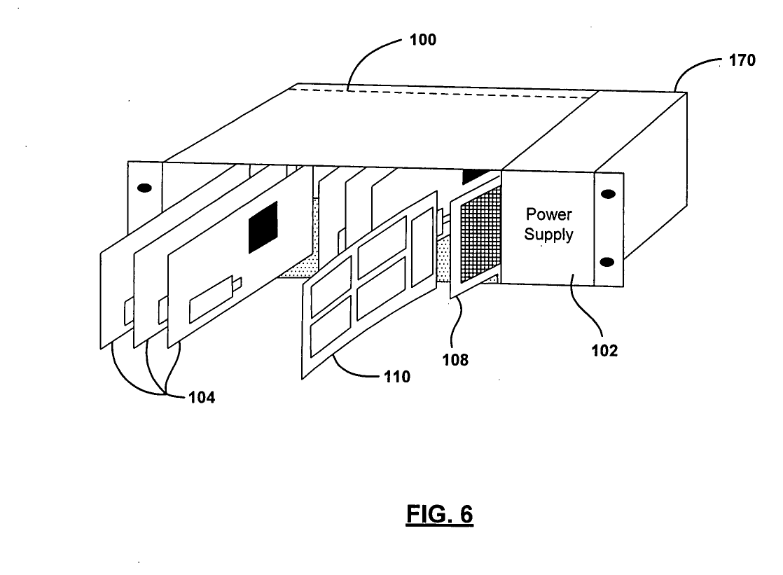

Referring now to FIG. 6, a housing 170 is illustrated having various circuit boards. The integrated bus 100 is show in a dash line. Each of the circuit boards 104, 110, 108 may be coupled to the bus 100. The power supply 102 may also be coupled to the bus 100. However, the power supply may also be a standalone unit. The bus may, for example, be a VME-type bus such as a VME 3U-type form-factor with a proprietary DIRECTV bus. This allows for easy accessibility of the circuit boards and easy replacement if required. Thus, a plurality of tuner and processor circuit boards 104 may be incorporated into the housing 170. Likewise, one or more modulator and combiner circuit boards 110 may also be disposed within the housing.

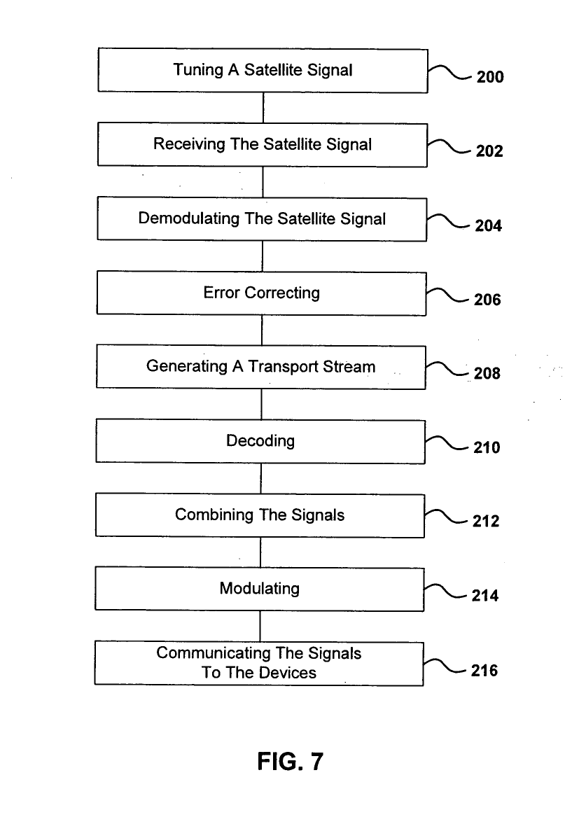

Referring now to FIG. 7, a satellite signal is tuned in a tuner in step 200. As mentioned above, the signal may be a satellite signal or may also be some other terrestrial or cable television signal. In the following example, the satellite signal, rather than a cable or terrestrial signal, will be used. In step 202, the satellite signal is received. In step 204, the satellite signal is demodulated. In step 206, error correction, such as forward error correction, may also be used on the signal. If error correction is used, step 206 is performed. A transport stream is generated in step 208.

In step 210, the transport stream is decoded such as by MPEG decoding. In step 212 the signals generated at the various tuner and processor circuit boards are combined. In step 214 the combined signals are modulated. In step 216, the modulated signals are communicated to the devices and the signals displayed. The display may be in audio display or visual display.

While particular embodiments of the disclosure have been shown and described, numerous variations and alternate embodiments will occur to those skilled in the art. Accordingly, it is intended that the disclosure be limited only in terms of the appended claims.

What is claimed is:

1. A receiving unit comprising:
a plurality of tuner and processor circuit boards receiving satellite signals, said plurality of tuner and processor circuit boards demodulating and decoding the satellite signals to form a first plurality of audio and video signals;
a modulator and combiner circuit board separated from the tuner and processor circuit board receiving the first plurality of audio and video signals and modulating and combining the plurality of audio and video signals to form a modulated and combiner output signal; and
an integrated bus comprising coupling the plurality of tuner and processor circuit boards with the modulator and combiner circuit board.

2. A receiving unit as recited in claim 1 further comprising a controller card is in communication with the plurality of tuner processor circuit boards through the integrated bus.

3. A receiving unit as recited in claim 2 wherein the controller card is in two way communication with the plurality of tuner and processor circuit boards.

4. A receiving unit as recited in claim 1 further comprising a power supply circuit board separate from the tuner and processor circuit board.

5. A receiving unit as recited in claim 1 wherein said power supply board is in communication with the integrated bus.

6. A receiving unit as recited in claim 1 wherein plurality of tuner and processor circuit boards comprising a tuner generating a transport stream signal.

7. A receiving unit as recited in claim 1 wherein the integrated bus comprises an inter-integrated circuit bus.

8. A receiving unit as recited in claim 1 wherein the integrated bus comprises a VME circuit bus.

9. A satellite television receiving system comprising a receiving unit as recited in claim 1 and a multi-switch in communication with the plurality of tuner and processor circuit boards.

10. A satellite television receiving system comprising a receiving unit as recited in claim 1 and a multi-switch in communication with a controller circuit board.

11. A satellite television receiving system comprising a receiving unit as recited in claim 1 and a multi-switch in communication with a controller circuit board through the bus.

12. A satellite television receiving as recited in claim 11 further comprising a plurality of antennas coupled to the multi-switch.

13. A receiving unit as recited in claim 1 wherein the tuner and processor board is disposed in a first plane and the modulator and combiner circuit board is disposed in a second plane spaced apart from the first plane.

14. A method of distributing a satellite signal comprises:
receiving satellite signals from an antenna at the tuner and processor circuit board;
demodulating and decoding the satellite signals to form a plurality of first signals at a plurality of tuner and processor circuit boards;
communicating the plurality of first signals to a modulator and combiner circuit board;
combining the plurality of first signals to form a combined signal;
modulating the combined signal to form an output signal; and
communicating the output signal to a device.

15. A method as recited in claim 14 wherein communicating comprises wirelessly communicating the output signal to the device.

16. A method as recited in claim 14 wherein communicating comprises wirelessly communicating the output signal to the device through a video sender.

17. A method as recited in claim 14 further comprising selecting the satellite signals through a multi-switch.

18. A method as recited in claim 17 wherein selecting comprises controlling the multiswitch at the tuner and processor board.

19. A method as recited in claim 17 wherein selecting comprises controlling the multiswitch at a controller board.

20. A method as recited in claim 14 wherein communicating the plurality of first signals comprises communicating the first plurality of signals through a bus.

21. A method as recited in claim 14 wherein communicating comprises wirelessly communicating the output signal to the device.
